(19) United States
(12) Patent Application Publication
(10) Pub. No.: US 2016/0267247 A1
(43) Pub. Date: Sep. 15, 2016

(54) MEDICINE ADMINISTRATION SYSTEMS AND METHODS

(71) Applicant: Wal-Mart Stores, Inc., Bentonville, AR (US)

(72) Inventors: Donald R. High, Noel, MO (US); Nicholas D. Rone, Bella Vista, AR (US); Michael Dean Atchley, Springdale, AR (US)

(21) Appl. No.: 15/062,468

(22) Filed: Mar. 7, 2016

Related U.S. Application Data
(60) Provisional application No. 62/132,685, filed on Mar. 13, 2015.
(60) Provisional application No. 62/219,831, filed on Sep. 17, 2015.

(51) Int. Cl. G06F 19/00; G06K 7/14

(52) U.S. Cl. CPC G06F 19/3456; G06K 7/1417

(57) ABSTRACT

A system for medicine management, comprising a special purpose computer that associates collected data related to a medicine with an identification code that identifies an intended recipient of the medicine; a database that stores the identification code and the data associated with the identification code; a special purpose computer that determines whether a combination of the intended medicine recipient, the medicine, a time of administration of the medicine to the intended medicine recipient, and an administered dosage is correct; and a notification generator that generates a notification and outputs the notification to a user-defined notification recipient distribution.

### RELATED APPLICATIONS

This application claims priority to U.S. Provisional Application Ser. No. 62/132,685, filed on Mar. 13, 2015 entitled “SYSTEM AND METHOD FOR PROVIDING MEDICINE ADMINISTRATION NOTIFICATIONS”, and U.S. Provisional Application Ser. No. 62/219,831 filed on Sep. 17, 2015 entitled “MEDICINE ADMINISTRATION SYSTEMS AND METHODS” the entirety of each of which is incorporated by reference herein.

### FIELD

The present concepts relate generally to the administration of medicine, and more specifically, to systems and methods for providing notifications and generating location information related to the administration of medicine.

### BACKGROUND

Modern healthcare offerings provide for the distribution of medicine from a pharmacy where a prescription is filled to a location where people can receive the prescribed medicine such as a school or home. The medicine can be administered by a caregiver.

### BRIEF SUMMARY

In one aspect, provided is a system for medicine management, comprising: a special purpose computer that associates collected data related to a medicine with an identification code that identifies an intended recipient of the medicine; a database that stores the identification code and the data associated with the identification code; a special purpose computer that determines whether a combination of the intended medicine recipient, the medicine, a time of administration of the medicine to the intended medicine recipient, and an administered dosage is correct; and a notification generator that generates a notification and outputs the notification to a user-defined notification recipient distribution regarding at least one of an issuance of the medicine to the intended recipient or in response to a determination that the combination of the intended medicine recipient, the medicine, the time of administration of the medicine to the intended medicine recipient, and the administered dosage is incorrect.

In some embodiments, the system further comprises a tracking system that receives data from the identification code on a container storing the medicine, and in response monitors the administration of medicine by the caregiver.

In some embodiments, the system further comprises a scanning device that scans the identification code to retrieve the data from the identification code prior to administering a dose of the medicine to the intended recipient.

In some embodiments, the notification includes at least one of a notification when the scanning does not scan the identification or a notification in response to monitoring the administration of the medicine.

In some embodiments, the identification code includes a quick response (QR) code.

In some embodiments, the notification includes at least one of a proactive alert, a reactive alert, and a neutral alert.

In some embodiments, the user-defined notification recipient distribution includes at least one of a caregiver, a family member, a friend, or other non-medical person.

In some embodiments, the system further comprises comprising a server that includes entity enrollment data, and wherein the notification generator outputs the notification according to the entity enrollment data.

In some embodiments, the system further comprises a processor that receives from the database one or more of prescription data, delivery information, medical administration data, or other information from the medical data file corresponding to the recipient ID code, and in response generates an event result that used by the notification generator to generate the notification.

In another aspect, provided is a method of providing information about an administration of medicine, comprising collecting data from a medicine prescription fill for an intended medicine recipient; generating an identification code for an intended medicine recipient and co-locating the identification code with a container holding the medicine prescription fill; creating a record that associates the collected data with the identification code; designating, by a non-medical user, one or more notification recipients for receiving a notification regarding events related to an administration of medicine of the medicine prescription fill to the intended medicine recipient; determining an event regarding at least one of the intended medicine recipient, the medicine, a time of administration of the medicine, a dosage of the medicine, or an administration route; and generating the notification for the designated one or more notification recipients in response to determining the event.

In some embodiments, the method further comprises determining the event prior to a scan of the identification code; and generating the notification as a pre-scan notification in response to determining the event prior to the scan of the identification code.

In some embodiments, the method further comprises scanning the identification code; and displaying an identifier of at least one of the intended medicine recipient and the medicine.

In some embodiments, the method further comprises determining the event in response to the scan of the identification code; and generating the notification as a pre-administration notification in response to determining the event.

In some embodiments, the method further comprises administering the dosage of the medicine to the intended medicine recipient; determining the event in response to the scan of the identification code and the administering of the dosage of the medicine; and generating the notification as a post-administration notification in response to determining the event.

In another aspect, provided is a method of notification, comprising: scanning an identification code on a container that includes medicine to identify a intended recipient of the medicine; determining in response to the scan whether the intended recipient, the medicine, a time of administration of the medicine, and a dosage of the medicine is correct; and generating a notification for a user-defined notification recipient distribution in response to a determination that at least one of the intended recipient, the medicine, the time of administration of the medicine, and the dosage of the medicine is incorrect.

In some embodiments, the method further comprises determining the event prior to a scan of the identification code; and generating the notification as a pre-scan notification in response to determining the event prior to the scan of the identification code.

In some embodiments, the method further comprises scanning the identification code; and displaying an identifier of at least one of the intended medicine recipient and the medicine.

In some embodiments, the method further comprises determining the event in response to the scan of the identification code; and generating the notification as a pre-administration notification in response to determining the event.

In some embodiments, the method further comprises administering the dosage of the medicine to the intended medicine recipient; determining the event in response to the scan of the identification code and the administering of the dosage of the medicine; and generating the notification as a post-administration notification in response to determining the event.

In another aspect, provided is a system for medication management, comprising: a device that reads a scannable identification code on a container at a first location where a medication is provided to the container; a device that provides an identification of a person receiving the medication for colocation on the container with the scannable identification code; a first processor that generates an association between the identification and the scannable identification code; a mobile electronic device at a second location that collects biometric data related to the person receiving the medication at a second location; a second processor that compares the biometric data to the identification on the container, and determines the identity of the person receiving the medication; and a notification generator that generates a notification for a user-defined notification recipient distribution in response to the comparison.

In another aspect, provided is a system for locating a medication recipient, comprising: a tracking system interface that communicates with a mobile electronic device proximal to a source of medication to receive from the mobile electronic device data related to a location of the mobile electronic device; a location processor that outputs the data related to the location of the mobile electronic device to a location storage device in response to an action performed at the location with respect to the source of medication; an action recording device that receives from the mobile electronic device data related to the action; and the location storage device for storing a record formed that combines the location data with the data related to the action performed at the current location.

In some embodiments, the system comprises a report generator for generating a communication regarding at least one of the action or the location data.

In some embodiments, the system further comprises an application executed on the mobile electronic device that tracks the location of the source of medication.

In some embodiments, the action includes scanning by the mobile electronic device a code associated with the medication, and wherein the location is established in response to the scanning.

In some embodiments, the location processor determines whether a medication recipient is in transit while receiving a dose of the source of medication.

In some embodiments, the location processor determines source inventory supply levels.

In some embodiments the location processor retrieves the data related to the location from the mobile electronic device in possession by a recipient or caregiver of the medication.

In some embodiments, the mobile electronic device displays a result indicating a location of the recipient or caregiver relative to the medication.

In some embodiments, the location data is processed to determine where a recipient last took the medication for maintaining inventories at the different locations.

In some embodiments, the tracking system interface receives a location signal from the mobile electronic device on a predetermined basis, which is used by the location processor to establish whether the mobile electronic device is in transit while taking medication, or to determine how far the mobile electronic device is from the medication.

In another aspect, provided is a method for tracking a medication recipient, comprising: registering with a program; filling a prescription for medication in accordance with the program; scanning an identifier on a container holding the medication; and determining a location of the prescribed medication in response to scanning the identifier.

### BRIEF DESCRIPTION OF THE SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts.

FIG. 1 is a block diagram of a medicine administration environment, in accordance with some embodiments.

FIG. 2 is a block diagram illustrating functional components of a notification system, in accordance with some embodiments.

FIG. 3 is a flow chart of a method for generating a notification, in accordance with some embodiments.

FIG. 4 is a flowchart of a method for generating a notification, in accordance with some embodiments.

FIG. 5 is a block diagram of a location analysis system of FIG. 1, in accordance with some embodiments.

FIG. 6 is a flowchart of a method for tracking a medication recipient, in accordance with some embodiments.

FIG. 7 is a component model of an environment in which embodiments of the present inventive concepts are practiced.

FIG. 8 is a location tracking process flow, in accordance with some embodiments.

### DETAILED DESCRIPTION

A person may require medicine that is prescribed or recommended by a doctor or other qualified professional. In supplying the medicine, many pharmacies offer online programs that include patient profile information, prescription history data, refill options, drug information, and so on. A communication network such as the internet may be used to facilitate the delivery of such information. Typically, after a pharmacy fills a prescription for a customer (e.g., the doctor's patient), the patient or a person acting on the patient's behalf will either pick up the prescription at the pharmacy, or provide delivery instructions for the prescription.

In brief overview, systems and methods are provided that reduce the number of errors related to the disbursing of prescribed medicine or the like at schools or other facilities. When prescriptions are filled, a scannable recipient identification (ID) code is associated with the medicine along with an intended recipient's identification, such as a photograph, as well as other information such as parent contact information, scheduling details, and dosage amounts, which can be printed along with the recipient ID code on the bottle, container, or related storage device holding the prescribed medicine, or stored at a database for subsequent electronic retrieval and display.

These features permit authorized school staff or other non-medical caregiver to use a personal electronic device such as a smartphone, also referred to as a caregiver device, and after receiving authorization upon login or other security-related approval, to identify what medications belong to which recipient, for example, each patient, and when to administer the medication. The systems and methods can also generated notifications for parents, guardians, or other representative of the child when the child is to receive the medication, or has missed a prescheduled dose of medication. Alerts, alarms, warnings, messages, and/or other notifications can be generated to ensure that a correct medicine, intended recipient, time, dose, and/or route of administration of the alerts, for example, through a central computer system communicating through the network 12.

A location tracking feature may also be provided that permits pharmacy customers to document the location of the medicine recipient at the time of medication administration. Location information can be provided to authorized caregivers and/or recipients. Each time the medication is scanned or a smart device is used, the smart device can record its global position and associate it with actions being taken. The location information along with information on an action being taken can assist a recipient or caregiver with tracking a location of medication.

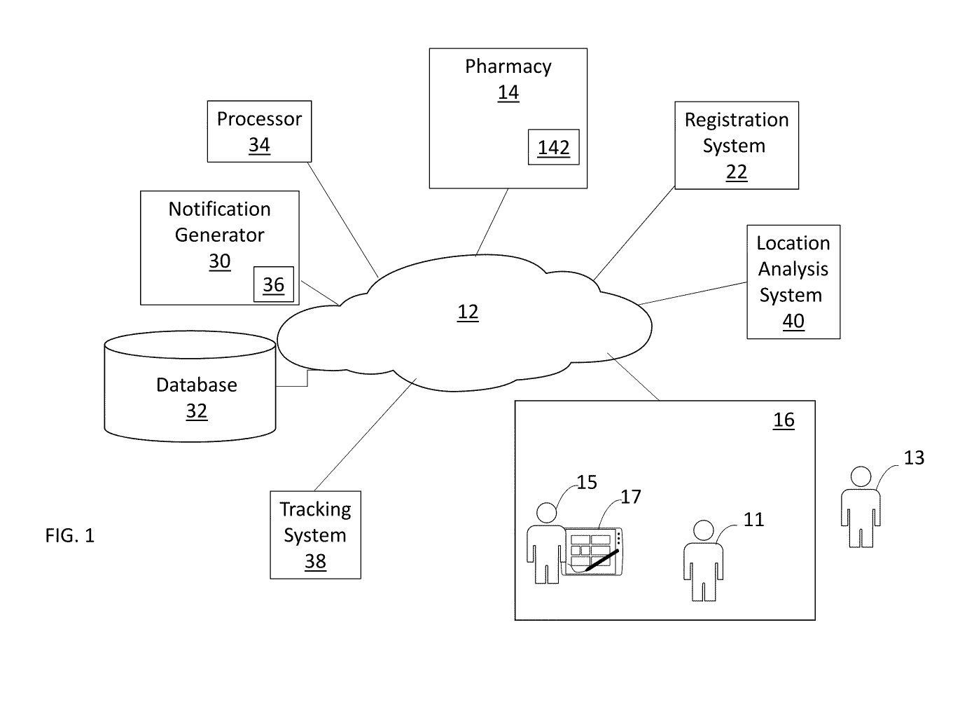

FIG. 1 is a block diagram of a medicine administration environment, in accordance with some embodiments. The medicine administration environment includes a communications network 12 that permits the various entities of the environment to communicate with each other. Entities can include a prescription processing facility such as a pharmacy 14 and a facility 16 at which a caregiver 15 provides prescribed medicine to an intended medicine recipient 11, for example, a school, hospital, doctor's office, outpatient location, home, and so on. Although the caregiver 15 and intended medicine recipient 11 are referred to as different people, they can be the same person. For example, the medicine recipient 11 can be adult who can administer doses of medicine. The medicine can be a medication that is prescribed by a doctor or other medical professional, or the medicine can be an over-the-counter medicine such as aspirin or cough medicine.

The medicine administration environment includes functional components for performing various operational steps related to medicine administration-related notifications, including but not limited to a registration system 22, a notification generator 30, a database 32, at least one processor 34, a tracking system 38, and/or a location analysis system 40. Some or all of the functional components can be co-located at the pharmacy 14 and/or administering facility 16, or can be geographically separate at a separate location, and can communicate with each other and/or the pharmacy 14 and/or administering facility 16 via the network 12, for example, a public switched telephone network (PSTN), a mobile communications network, a data network, such as a local area network (LAN) or wide area network (WAN), or a combination thereof, or other communication network known to those of ordinary skill in the art. In addition to the caregiver 15 and intended medicine recipient 11, other interested parties such as a parent 13 or guardian of the intended medicine recipient 11, and/or a doctor or other party (not shown) may each have an electronic computer device such as a smartphone, laptop, and so on, for communicating with the various functional components for performing one or more functions related to the administration of medicine to the intended medicine recipient 11.

The pharmacy 14 and/or the administering facility 16 can register with a medicine administration program at the registration system 22. Each intended medicine recipient 11 eligible to provide consent (for example, over 18 years old), and/or parent 13 or guardian, and/or caregiver 15 representing the intended medicine recipient 11, may enroll at the program at the registration system 22. To access the registration system 22, the entities (facility, pharmacy, guardian, parent, and so on) can have an application installed on the electronic device to identify the entities for security purposes. Enrollment in this manner permits the parent 13, guardian, or other representative of the recipient 11 to authorize access to medical data regarding the recipient 11. In this manner, the parent 13 or guardian to authorize the caregiver 15 to access this information via the program. Also the parent 13, guardian, or other custodian of the intended medicine recipient 11 may register with the program in order to be authorized to access information from the pharmacy 14. When a parent 13 registers, the parent 13 can enroll dependents such as the child recipient 11, whereby medical information on the dependents are accessible for generating notifications, described below.

The program permits communication between the entities by permitting caregiver 15 and/or parent 13, and/or other school official, to identify which medications belong to which patients, when to administer the medications, to determine a delivery route from the pharmacy 14 and the administering facility 16, and so on. For example, a registered parent 13 can receive via the program a list of participating pharmacies, and select a pharmacy for providing the prescribed medicine to the intended medicine recipient 11. In another example, the program may provide features for permitting a participant to keep track of which prescriptions must be refilled, and the dates at which a refill is to occur. In a medicine refill program, the recipients' medicine can be supplied to the administering facility 16 for administering to the intended medicine recipient 11 by the caregiver 15. Information about the intended medicine recipient 11, the medicine, dosage, delivery, and so on can be entered at the registration system 22, and collected and stored in the database 32. Other information is gathered during enrollment at the registration system 22 can include information gathered by the pharmacy 14, such as medicine details, administration instructions such as taking the medicine after a meal, dosage amount, and so on.

When filling a prescription for a medicine, a pharmacist places the prescribed medicine into a bottle or other appropriate container. In embodiments where the recipient 11 is a new customer of the pharmacy 14, a recipient ID code is generated for the new recipient 11, or to the parent, guardian, or authorized representative of the recipient 11. A software application at the server 142 assigns a unique ID code corresponding to the intended medicine recipient 11 and/or the recipient's parent or guardian 13. A medical data file, or customer record, is also created for the recipient 11, for example, including patient name, address, or other identification information. The medical data file can be formed with the ID code, for example, at the pharmacy server 142. The contents of the medical data file can be stored in the database 32. Additional information can be added via an application on the guardian smartphone 17 or other electronic device. When the recipient ID code is created for a prescription by the pharmacist, the ID code is placed on the container holding the prescribed medicine, the recipient ID code can link and uniquely identify the filled prescription of the customer to a customer's medical data file or record stored on the pharmacy server 142 and/or at the database 32 at a remote location. Other information can also be linked to the ID code and medical data file such as instructions for taking the medicine. A user such as the caregiver 15 can be directed to the patient identification and user menu once logged into the system

If the intended medicine recipient 11 is an existing customer requiring a refill, then preferably the same ID code is used for all prescription data belonging to the recipient 11. Here, the pharmacist verifies that the container for refill matches the prescription by scanning or otherwise reading the label on the selected container. Alternatively, a separate ID code can be assigned to the recipient 11 for each separate prescription. The recipient ID code is printed or otherwise marked or added to the container, to a label on the container, or onto an attached document such as instructions for taking the medicine.

The recipient ID code and the label for the container are preferably printed at the same time to ensure that the correct ID code is attached to, marked upon, or otherwise accompanying, the container for each individual prescription. Any type of ID code can be used by way of any known method, such as but not limited to, a scannable barcode, a QR code, a magnetic strip code, an OCR (optical character recognition code), an encrypted code, standard alpha-numerical characters, a code identifiable by digital imaging, or any other code. The ID code can store URLs or other information, which can point to the customer's medical data. For example, the ID code can include a web page address, or uniform resource locator (URL) for the customer's patient prescription for a specific patient. The ID code can be read by a camera on a smartphone 17 or other code-reading device such as a barcode reader or scanning device for reading printed barcodes such as a barcode or QR code from the label of the medicine container.

As described above, if the prescription being filled is for a new customer, then a new customer record can be created, which is linked for access to the customer's ID code and stored in the database 32. If a medical data file for the customer already exists in the database 32, then the new prescription data can be added to the customer's existing medical data file. The pharmacist can also set up login information for a new customer such as a user name and password to allow the customer, after the prescription has been filled, to be able to login at a pharmacy website available on the Internet (which can include network 12). Alternately, the customer could use the assigned ID code along with an identifier such as a name and/or other identifying data to create a new account.

In addition to the customer's personal information, the pharmacist can enter other information in predetermined entry fields mapped to the customer's medical data file such as information identifying the customer's prescribed medicine, dosage, and the name of the doctor who is prescribing the medicine. The medicine can be prescribed for a specific time period and a specific number of refills, such as 30 pills to be taken daily, and refilled once a month for a period of one year.

Other information may include the medical history, clinical outcomes, and allergic reactions to certain types of drugs and similar kind of information related to the patient, which can be obtained via the network 12 from other sources of patient data.

Also, at the time of the fill, the pharmacy 14 may take or receive a digital image or photograph or other identifier of the intended medicine recipient 11, which can be stored with the recipient's medical data file at the database 32 which is mapped to the recipient ID code by the processor 34. The digital image identifier can be used for biometric scanning such as facial recognition. Other biometric attribute data can alternatively be captured in addition to, or instead of, a photo id, such as data for performing a fingerprint scan, retina scan, iris scan, voice recognition, biochemical identifiers, and so on.

Other information such as medicine prescription data, dose quantity, route of administration, incremental times that authorized caregiver may dispense the medicine, contact information such as text number, email, or alternative method of notification, and so on can likewise be linked to the ID code and stored at the database 32. For example, when the smartphone 17 detects an issue, it can notify a central computer through the network 12. The central computer can output a communication (i.e., text, email, and so on) to the user-defined notification recipient, along with information such as patient information (name, data, medication, type of issue, and so on). Some or all of the data can be printed and attached to the bottle or other container holding the prescribed medicine.

For example, when a customer picks up a prescription at the pharmacy 14, the customer may provide contact information such as a phone number, email address, or other information for receiving notifications. This information can be entered at the smartphone 17 or other electronic device via a secured connection to the database 32 and/or pharmacy server 142. The customer can later change this information by logging into the system and entering the new information. The pharmacy 14 can initiate a program for the registered customer. The customer can download an application to make subsequent changes to notification information, or to add other contact information to a notification recipient list.

Additional information can include instructions for taking the medicine which includes guidelines and tolerances, set by the recipient's doctor, for proper care, usage and administration of the medicine. For example, a prescription may be filled for the recipient 11 who is required to take one pill twice a day, once in the morning after breakfast and the second time in the early evening after a meal. Let us assume that the effectiveness of the medicine is maximized if the pills are taken at 12 hour intervals and the pills are still relatively effective if taken within 8 to 14 hours of one another. Also, let's assume that damage to the recipient's stomach lining could occur if the medicine is not taken immediately after or during a meal. In this case, the tolerances could be set to taking one pill in the morning during or immediately after breakfast between 7-10 am, and one pill in the evening during or immediately after dinner between 7-10 pm. Notifications can be generated in accordance with some embodiments, before, during, and/or after the recipient 11 takes the pills, depending on events related to the administration of the pills to the recipient 11.

After a prescription is filled, the container holding the prescribed medicine is delivered to the administering facility 16. Here, the parent 13 or a person acting on behalf of the intended recipient 11, or the recipient 11 himself or herself, can either pick up the prescription at the pharmacy 14, or provide delivery instructions, for example, by entering the instructions into a computer that are electronically transmitted directly to the pharmacy server 142, or to the program's website or the like which communicates with the pharmacy server 142, or via the database 32 which stores the instructions with the medical data file corresponding to the recipient 11.

Prior to, during, or after the recipient 11 takes the medicine, the caregiver 15, the recipient 11, or other party such as a parent 13 can access the customer's medical data file on the pharmacy server 142, or a different storage location in communication with the pharmacy server 142, using a smartphone 17 or other electronic device in communication with the network 12 to scan the ID code on the medicine container.

After taking his/her medicine, the authorized caregiver 15 can log onto the database 32, or the pharmacy server 142, or other location where the medical data file is located, and access the medical data file using the recipient ID code.

The caregiver 15 can verify the identity of the intended medicine recipient 11 by visually comparing a photograph or other identifier of the intended medicine recipient 11 on the medicine container and/or a digitized photograph or the like that is displayed on the smartphone 17 after scanning the ID code. For example, the caregiver 15 can use a smart device 17 or the like to scan the ID code on the medicine container, visually inspect a photograph of the intended medicine recipient 11 on the medicine container to ensure that the right medicine is administered to the right person. In other embodiments, a fingerprint, retinal scan image, or other biometric identifier may be taken of the recipient 11 and compared by the processor 34 to previously captured biometric data corresponding to the recipient ID code and stored at the database 32. As described below, notification can be generated when the processor 34 determines that the biometric data does not match the identification on the medicine container.

The notification generator 30 facilitates the distribution of administration-related notifications, for example, alarms, warnings, or other informational notifications, regarding the issuance of medicine to the recipient 11 and/or administration-related issues. For example, the notification generator 30 generates for a predetermined receiving party entity a notification regarding the combination of the user, the medicine, the time of receipt, and the dosage. The notification generator 30 includes a controller 36 that can be configured to send notifications in the form of emails, text messages, voice messages, face time, IVR, database updates, regular mail (non-electronic communication), or other form of communication to one or more user-defined notification recipients, for example, parents, school officials, emergency contacts, and so on, when exceptions to a predetermined medicine administration occur. The email addresses, phone numbers, or other notification data can be stored at the pharmacy server 142. The notification recipients can be identified by the intended medicine recipient 11, the caregiver 15, the parent 13, or other authorized person. Contents of notifications can be automatic, for example, predefined and stored at the database 32 or other data repository. Alternatively, user-defined notifications can be generated. For example, an authorized system user can type and output the text for a particular notification to the notification generator 30.

The notification generator 30 can generate alerts according to an escalation schedule, for example, depending on the severity that his predefined by the program, or other authorized user, including but not limited to patients, medical care providers, and insurance providers.

Tracking system 38 receives data generated from the scan by the caregiver's electronic device 17, which can be used for monitoring the administration of medicine, and for tracking how well the caregiver 15 does with the administration of medicine. For example, after the ID code is scanned, the caregiver 15 can press an acknowledgement button or other triggering element on the smartphone 17 which confirms that an action was taken, for example, that the intended recipient 11 consumed a dose of medicine. Details such dose quantity, time of consumption, and so on can also be received and processed. The notification generator 30 may generate an alert if the caregiver 15 under or over administers medicine according to predetermined doses. For example, administration instructions can establish that the user is supposed to receive a pill every 4 hours. The tracking system 38 may establish that the guardian provided 2 pills, or missed a 4 hour window, which can be recorded by the tracking system 38 for future reporting, for example, on the caregiver's administration record.

Location analysis system 40 retrieves from the tracking system 38 location information, in particular, the location of the person in possession of the medication such as the caregiver 15, the recipient 11, or other person also in possession of an electronic device configured so that the person can be tracked via the electronic device, and provides information about customer prescriptions with respect to the location of actions associated with the medication.

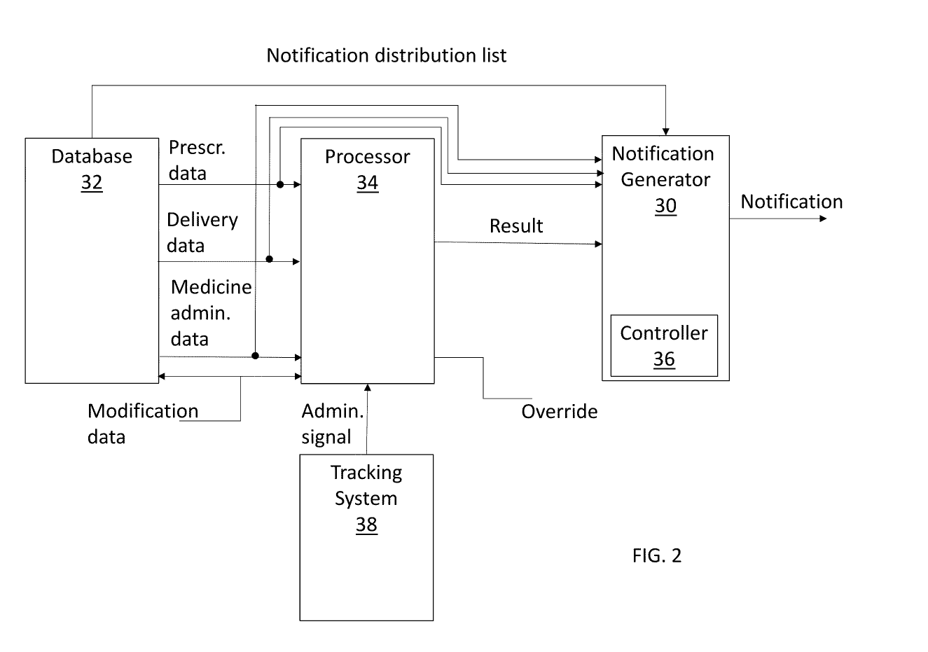

FIG. 2 is a block diagram illustrating functional components of a notification system, in accordance with some embodiments. The notification system may include the database 32, processor 34, notification generator 30, and tracking system 38 of FIG. 1.

The processor 34 receives from the database 32 one or more of prescription data, delivery information, medical administration data, or other information from the medical data file corresponding to the recipient ID code. Although this information may be stored and retrieved from the database 32, some or all of the data may be stored and retrieved from another memory location, for example, at the pharmacy database 142 of FIG. 1. Other information may be received and processed at the processor 34 that is not linked to the recipient ID code. For example, a database of medicine-related information may include recommended doses for a particular medicine that is not included in the recipient's medical data file, but may be used for comparing with an actual dose administrated to the recipient 11.

The processor 34 may also receive an administration signal from the tracking system 38 that includes actual administration information, for example, when, where, and how much of a dose was actually given to the recipient 11. The processor 34 can generate a result from this information. Once a dose is administered to the recipient 11, the administration signal is generated, which can be used to generate a notification of the administration. For example, the processor 34 can compare an actual dose of 2 pills taken to stored instructions that only 1 pill is to be taken and generate an event result that an overdose was administered. The result can be output to the notification generator 30 which generates a notification to a user-defined set of notification recipients. For example, once the caregiver 15 performs a receiving scan, the notification generator 30 outputs an electronic notification in the form of a text message, email message, voice message, and so on, to the parent 13 that the caregiver 15 has received the medicine for administering to the recipient 11.

The notification generator 30 can generate at least one of a proactive alert, a reactive alert, and a neutral alert. A proactive alert pertains to an action that needs to be taken, for example, a reminder that a medicine needs to be taken at a particular time. Here, the processor 34 can determine that a dose of medicine is to be administered in 1 hour, and output a result to the notification generator 30 that it is currently 1 hour from the expected dose administration time. A reactive alert pertains to an administration-related issue that has occurred, for example, a missed administration of medicine, medicine not given on time, or a notification of a completed administration of medicine. The notification can include information designating the time, amount, and name of medicine, and so on. A neutral alert may pertain to a message from one user to another user, for example, a reminder by a parent 13 or pharmacist to the caregiver 15 that the recipient 11 must have a small meal prior to ingesting a dose of medicine.

In some embodiments, the notification processor 30 can generate a delivery-related notification that the medicine has arrived at the school 16. The notification processor 30 can receive delivery information from the database 32 or pharmacy server 142, or other information source to determine an estimated arrival day/time, location information, or other delivery information. The caregiver 15 can confirm delivery when the prescribed medicine arrives at the school 16. Confirmation can be provided by an electronic acknowledgement sent from the smartphone 17 or via a website or other electronic exchange.

In some embodiments, the notification processor 30 can generate one or more internal notifications. One internal notification can include a welcome or test alert notification that is provided to new users. The welcome/test alert notification can be provided as a text message or automated voice recording to the user's smartphone associated with the phone number, or an email message.

Another internal notification may relate to the time for administration of medicine. A notification can be generated as to when the patient is to take the medicine. As described herein, the caregiver 15 can press an acknowledgement button or other triggering element on the smartphone 17 which identifies a time when a dose of medicine is administered to the recipient 11. Therefore, an alert can be generated when the medicine is not filled on schedule or administered on time. For example, if the caregiver 15 does not scan the medicine within a certain specified time, then the system may notify the pharmacy 14 and/or the parent 13.

Another internal notification can relate to incorrect entries. Entries may be made from the smart device 17, web application, or other computer-related entry. Here, the caregiver 15 or other user may acknowledge the amount, time, and/or location of medicine to be administered, as well as the intended recipient to confirm that the correct medicine is to be administered to the correct person at the correct time at the correct dose. In doing so, an application on the smart device 15 communicates with the scanner to require the caregiver 15 to scan the medication container and enter this information for each administration of medicine. If there is a discrepancy, then a notification can be generated.

Another internal notification can relate to medicine inventory adjustments, for example, due to erroneously entered data regarding medicine amounts. When the caregiver 15 receives a prescription of medicine, and scans the ID code, a notification can be provided that there is sufficient medicine in inventory for recipient 11, or an alert that there is depleted or insufficient medicine in inventory. An inventory amount may be displayed. Each time the caregiver 15 administers medicine, the smartphone 15 can scan the recipient ID code on the container, enter the dose to be administered, which is subtracted from a predetermined inventory quantity. When the inventory is reduced to a predetermined threshold, notifications can be generated informing a user-specified audience of the inventory depletion.

For example, if the caregiver 15 notices that the inventory amount displayed at a program-related screen does not match what is actually physically in the container, the caregiver 15 may notify the parent 13 or pharmacy 14. In another example, a refill alert may be generated that is sent to the pharmacy 14 that a refill for a particular medicine is required.

Another notification may relate to medicine recalls, where the caregiver 15, parent 13, or other recipient may receive recall information. Recall notifications can be repeatedly provided until the inventory comprising the recalled medicine is removed. Since the pharmacy server 142 processes medicine-related information, when notified of a recall, the pharmacy server 142 notifies the notification generator 30, which outputs notifications to the user-defined notification recipients, for example, including information not to use remaining medication and so on. Such messages can be predefined and stored at the database 32 for retrieval and insertion into the notifications to be output.

The notification processor 30 can generate one or more external transmissions, are similar to internal notifications except for the identified notification recipient audience, which may include organizations, caregivers, doctors, pharmacies, third-party recipients such as friends or backup contacts.

The notification processor 30 may generate other notifications, alerts, or the like such as inquiries from other users, application information updates such as information about future improvements in a particular medication, emergency alerts, for example, contradicting medicines, medicine expiration warnings, inventory levels, override events, for example, where an authorized caregiver changes the medical data file to include a different dose amount, medicine recall information, for example, or other notifications related to the administration of medicine to the intended recipient 11. In addition to automatic notifications, the system allows users to notify each other manually. For example, one user may send a message regarding a prescription to another patient or caregiver.

The processor 34 can receive an override signal by an entity, which can override a warning or other notification from the electronic device where the notification is displayed. A user interface may display an option to select an override. Therefore, the caregiver 15 can override a dose amount, time of administration, use of a recalled or expired medicine, whereby an override notification is generated. The entity, i.e., notification recipient, can enter text, select a button, and so on indicating that the warning or notification is to be ignored. The override selection may be stored in a history file at the database 32 that is linked to the recipient ID code, along with other messages regarding notifications, time stamp, and/or sender and receiver information.

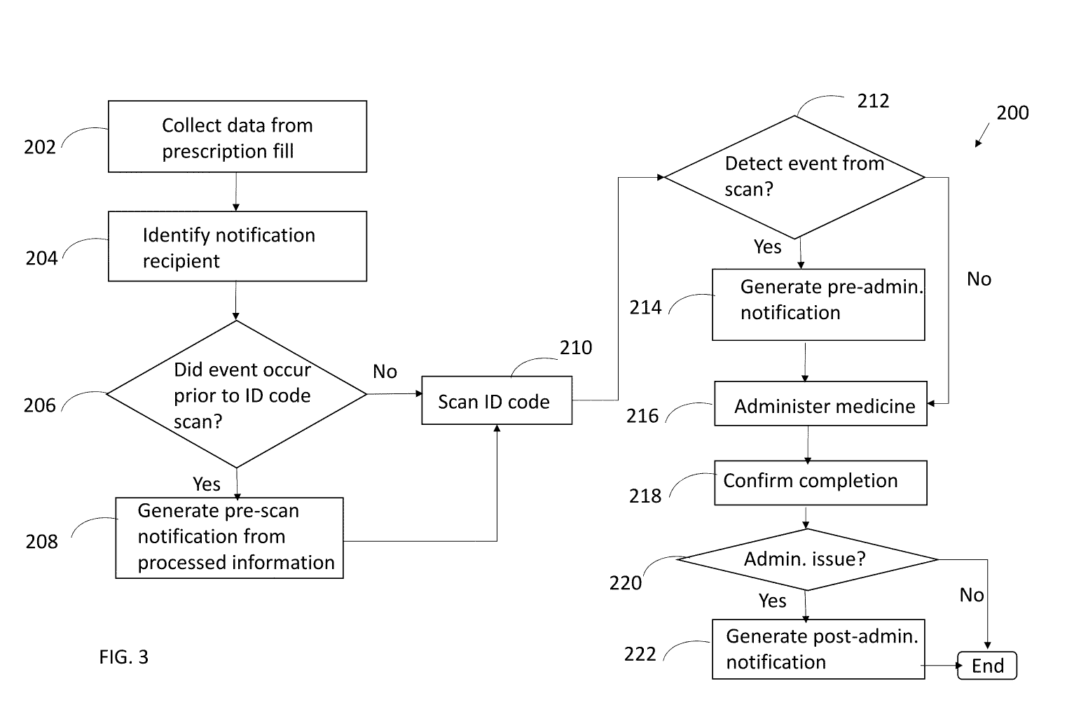

FIG. 3 is a flow chart of a method for generating a notification related to the administering of a medicine, in accordance with some embodiment. In describing the method, reference is made to FIGS. 1 and 2. Some or all of the method can be executed by elements of the medicine administration environment of FIGS. 1 and 2.

At block 202, data is collected from a prescription order is filled at the pharmacy 14 or other prescription processing facility and stored at database 32.

At block 204, one or more recipients of a notification are identified for receiving alerts, warnings, or other notification messages. Contact information for notification recipients such as email address, phone number, etc. can be stored in the medical data file associated with the recipient ID code.

At decision diamond 206, a determination is made whether an event occurred prior to a scan at the school 16 of the ID code on the medicine bottle by the caregiver 15, for example, using a scanning device that receives and processes the ID code and outputs it to an electronic communication device. In some embodiments, an event may be delivery-related, for example, a new supply of medicine did not arrive at the school 16 as anticipated, or that a current supply of medicine expired as determined by information in the database 32 indicating when the medicine was first sent, and expiration date on this medicine, which can be monitored by the tracking system 38.

If a pre-scan event is detected, then the method proceeds to block 208, where a pre-scan notification is generated to the notification recipients identified at block 204. Subsequently, the method 200 proceeds to block 210, where the ID code on the medicine bottle at the school 16 is scanned by an authorized person such as guardian 15 using a smartphone 17 or the like. When the ID code is scanned, identification information such as a photograph of the intended recipient 11 and/or the medicine to be administered can be displayed.

At decision diamond 212, a determination is made whether an event is detected in response to the scan. An example of an event is that the person performing the scan is not authorized to administer the medicine or to access information about the intended recipient 11. Other events relate to a determination that the medicine is intended for a different recipient, the medicine itself is incorrect, warnings regarding the administration of the medicine, and so on. If an event is determined, then the method proceeds to block 214, where a pre-administration notification is generated to the notification recipients identified at block 204.

A scan-related event may be determined by the processor 34, which can communicate with the pharmacy server 142 and/or other information source to retrieve and process the prescription data for comparison to actual medicine administration data. For example, the processor 34 can compare the information on the prescribed medicine to information received from the caregiver 15 regarding the actual administered medicine, and generate a result whether there is a match. Accordingly, the processor 34 can determine whether a combination of the user, the medicine, the time of receipt, and the dosage is correct.

At block 216, where the medicine is administered to the intended recipient 11. At block 218, the administration of the medicine can be confirmed, for example, by the guardian 15 selecting a button or the like on the smartphone 17. The administration of the medicine can be monitored by the tracking system 38, which may receive information regarding time, quantity, or other administration-related data. The recipient 11, or parent 13 or guardian, can receive a notification that the medicine was provided to the recipient 11, and can include information such as time, amount, name of medicine, or related information. This notification can be generated in response to the caregiver selecting a button at a user interface displayed on the smartphone 17 from an application that processes caregiver administration details and stores the result data at the database 32. If the medicine cannot be administered, the caregiver 15 can cancel a previously selected action and enter a reason at the smartphone 17. The notification generator 30 can generate and output a new notification to the user-defined notification recipients.

At decision diamond 220, a determination is made whether an administration-related issue occurred. If yes, then the method proceeds to block 222, where a post-administration notification is generated to the notification recipients identified at block 204. A notification may be generated of warnings that are overridden or other user-specified issues. For example, issues such as a reaction to a particular medication, missing medication, damaged medication, and so on can be identified in such warnings.

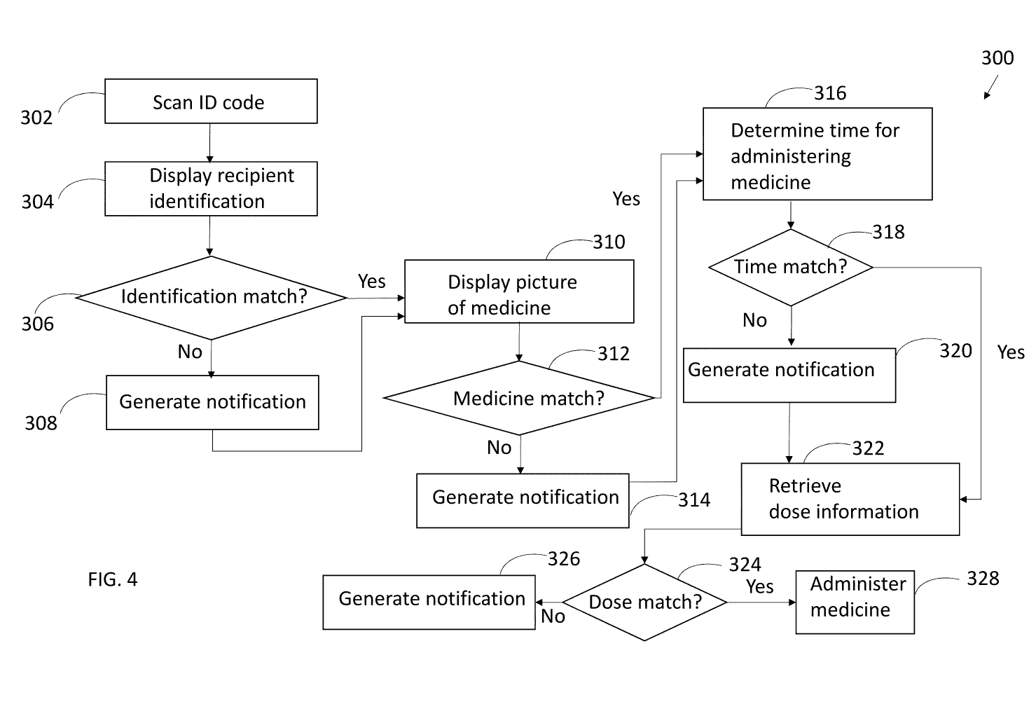

FIG. 4 is a flowchart of a method 300 for generating a notification, in accordance with some embodiments. In describing the method 300, reference is made to FIGS. 1-3. The method 300 is typically performed, but not limited to, during a time when the caregiver 15 scans the ID code on the medicine bottle and a time when the medicine is to be administered.

At block 302, a recipient ID code on a medicine container is scanned by a person responsible for administering medicine to a recipient 11, for example, a guardian 15. Although not shown, a notification can be generated if the caregiver 15 does not scan the ID code within a predetermined time. The notification can be sent to a predetermined notification recipient such as the pharmacy 14 that filled the prescription, the guardian 15, or one or more other receiving audiences. On the other hand, a notification can be generated if the caregiver 15 performs the scan, indicating that the medicine has been received.

At block 304, a photograph or other recipient identification is displayed, for example, on the smartphone 17 of the guardian 15 administering the medicine. The recipient identification is retrieved from the database 32 in response to the scanning of the ID code.

At decision diamond 306, a determination is made whether the displayed recipient identification in response to the scan of the ID code matches the physical description of the intended recipient 11, for example the child at the school 16. The caregiver can therefore immediately determine whether the recipient 11 is indeed properly identified for receiving the medicine corresponding to the scanned identification code. The match can be made by a visual observation by the administrator of the medicine or other person, or the match can be made using biometric technology or the like, for example, taking a picture of the recipient 11 prior to administering the medicine, and executing a facial recognition program. If there is no match, then the method proceeds to block 308, where a notification is generated to one or more predetermined notification recipients. If there is a match, then the method proceeds to block 308.

At block 310, the system displays information regarding the medicine to be administrated to the recipient 11, for example, a digital image of the medicine, and/or a description, which can be displayed on the smart phone 17. The caregiver 15 can therefore immediately determine whether the medicine corresponding to the scanned identification code is correct for providing to the recipient 11. The medicine information can be displayed along with the photograph of the recipient 11. The association between the recipient 11 and the identified medicine can be established prior to administration of the medicine to the recipient 11.

Accordingly, at decision diamond 312, a determination is made whether the displayed digital image of the medicine matches the physical description of the medicine intended for administering to the recipient 11. The match can be made by a visual observation by the administrator of the medicine or other person, or the match can be made using technology which compares the actual medicine to the stored digital image of the medicine. If there is no match, then the method proceeds to block 314, where a notification is generated to one or more predetermined notification recipients.

If there is a match, then the method may proceed to block 316 where a time for administering the medicine is retrieved, for example, from database 32 or pharmacy server 142, which includes medicine administration instructions linked to the recipient ID code. The administration instructions may include the time when medicine is to be administered. Alternatively, a scheduler may be accessed which includes a predetermined time for administering the medicine.

As described above, the database 32 can be access to retrieve time-related instructions, for example, one dose of medicine every 4 hours. In other embodiments, the database 32 can be accessed without scanning the ID code, and therefore, block 302 may not be part of the method. In other embodiments that include block 302, the ID code is scanned which establishes a time when the medicine is about to be administered. Alternatively, time can be identified when the medicine is about to be administered by the caregiver 15 selecting a button or the like when the medicine is administered which creates a timestamp for comparison. At decision diamond 318, a determination can be made if the medicine is administered too early, too late, or on time, relative to the instructions in the database 32. If there is no match, then the method proceeds to block 320, where a notification is generated to one or more predetermined notification recipients. Related notifications can be generated that the medicine has been actually given, as opposed to the time after the scan but before the actual administration.

At block 322, other administration information such as a recommended dose of medicine per administration is retrieved, for example, from database 32 or pharmacy server 142, which includes medicine administration instructions linked to the recipient ID code. The administration instructions may include the correct dose of medicine to be administered.

At decision diamond 324, a determination can be made if the dose is too much, too little, or otherwise inadequate. If there is no match, then the method proceeds to block 326, where a notification is generated to one or more predetermined notification recipients. Related notifications can be generated that the medicine has been actually given, as opposed to the time after the scan but before the actual administration. Otherwise, the method proceeds to block 328, where the medicine may be administered according to an understanding that the correct medicine is being administered to the correct recipient at the correct time, and at the correct dose. In some embodiments, an error, alert, or other notification can be generated if the route of administration is incorrect, or amount is incorrect, or too much time has passed since the last administration. The notification can include a reason for the error, alert, and the like, and/or a suggested correction. With regard to a correct dose, a nurse or other caregiver can set the units to dispense on the device can have a default value of “0.” However, this can be changed to the administered amount. Incorrect units can result in an override, described above.

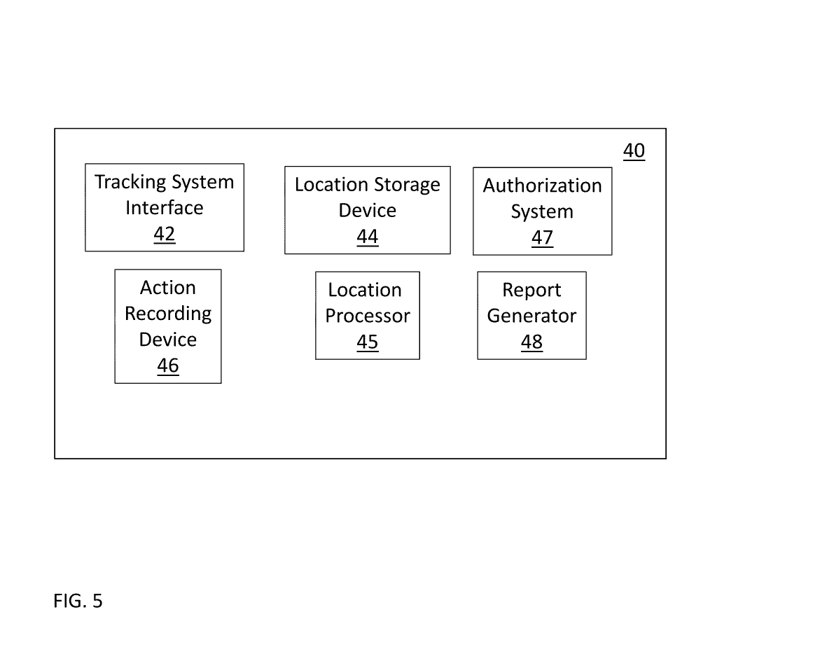

FIG. 5 is a block diagram of a location analysis system 40 of FIG. 1, in accordance with some embodiments. In describing the location analysis system 40, reference is made to at least FIG. 1

The location analysis system 40 may include a tracking system interface 42, a location storage device 44, a location processor 45, an action recording device 46, an authorization system 47, and a report generator 48. Some or all of the tracking system interface 42, location storage device 44, location processor 45, action recording device 46, authorization system 47, and report generator 48 may be part of a same hardware platform, or separate from each other on different hardware devices, and communicate with each other via the network 12.

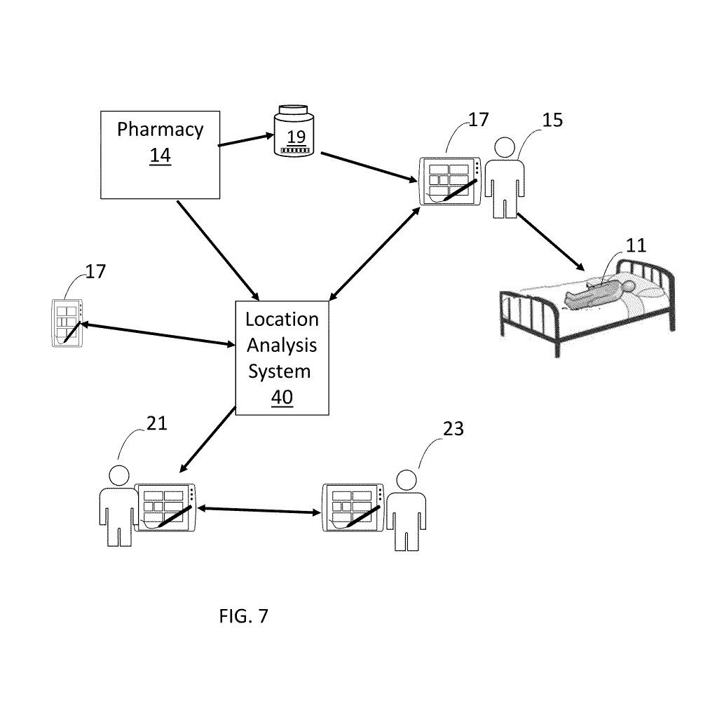

The tracking system interface 42 communicates with the mobile electronic device 17 of an authorized user, such as but not limited to the recipient 11, guardian 13, or caregiver 15. More specifically, the tracking system interface 42 exchanges a communication with a GPS device or related communication device of the mobile electronic device 17 to determine a current location of an electronic device 17. Although a smartphone is described, other electronic devices can equally apply. For example, the tracking system interface 42 can communicate with a life alert device on the possession of the medication recipient 11. In another example, the tracking system interface 42 may communicate with a tablet or notebook of the caregiver 15. The tracking interface module 42 may receive a location signal from the mobile electronic device 17 on a predetermined basis, for example, every 5 seconds, which can be used by the location processor 45 to establish whether the mobile electronic device 17 is in transit while taking medication, and/or used for GPS mapping, i.e., to determine how far the mobile electronic device 17 is from the recipient's medication. This occurs when the medication container 19 (see FIG. 7) is scanned. Here, GPS coordinates are captured.

The action recording device 46 captures an action taken at a particular location. In preferred embodiments, an action relates to the receiving by the medication recipient 11 a dose of medication. This may be determined by the caregiver 15 scanning a barcode on the medicine bottle 19 (see FIG. 7) indicating that the caregiver 15 is about to or has given a dose of medicine to the recipient 11. When this occurs, the current location along with the scan info are combined in a record and stored at the location storage device 44. The records can be used to determine the location where the recipient 11 last took the medication, etc. An action taken may be indicated by the user on an application executed on the mobile electronic device.

The location storage device 44 stores a plurality of records, the contents of each of which may include data related to a captured location along with the action performed at that location. For example, the tracking system interface 42 may receive from the electronic device 17 a location signal which includes GPS coordinates of a current location of the mobile electronic device 17. A record may be formed that combines this location data with data related to an action taken at the current location, for example, data results of a scan taken of the medicine bottle. The record may be stored at the location storage device 44. Some records may include only location data, and no corresponding actions. Here, the location storage device 44 stores location tracking data, for example, offices, pharmacies, hospitals, or related locations visited by the possessor of the mobile electronic device 17. In this manner, the stored location data can be subsequently retrieved and viewed by an authorized user. Authorization may be determined by the recipient 11 and/or other embodiments, for example, described herein.

The location processor 45 compares the location of the customer to the location of the medication using mapping. As described, the location of the medication may be tracked in response to scanning the medication, more specifically, a barcode or the like on a container 19 holding the medicine. The scanning operation triggers the mobile electronic device 17 to transmit the GPS location of the electronic device 17 to the location analysis system 40. This permits the customer to be reminded where the customer is relative to the medication and where the medication is located. When a user desires to know where there is an inventory of the medication of interest, the user can execute an application on the mobile electronic device 17 to track the location (GPS) of the location of each administration of medication based on the scanning operation. From the GPS coordinates, the user can determine how far the user (i.e., the possessor of the mobile electronic device 17) is from a source of medication. Also, the location processor 45 can determine from this data whether the medication recipient 11 is in transit while taking medication. The location processor 45 may provide location comparison results generated in response to a received scan result, for example, from a barcode, e.g., QR code or the like on the container of the medicine 19, to the location storage device 44. Also, inventory supply levels can be determined at the source of medication.

The report generator 48 can generate a report, statistical data, or other presentable format from the contents of the location storage device 44, and/or other data repositories, for example, an email server for retrieving email addresses of authorized report recipients. The report generator 48 can generate a message or related communication informing the recipient 11, guardian 13, caregiver 15, and/or other authorized person of recent activities, such as a recent dose of medication received by the recipient 11. This report information may be shared between family members or friends of the medication recipient 11.

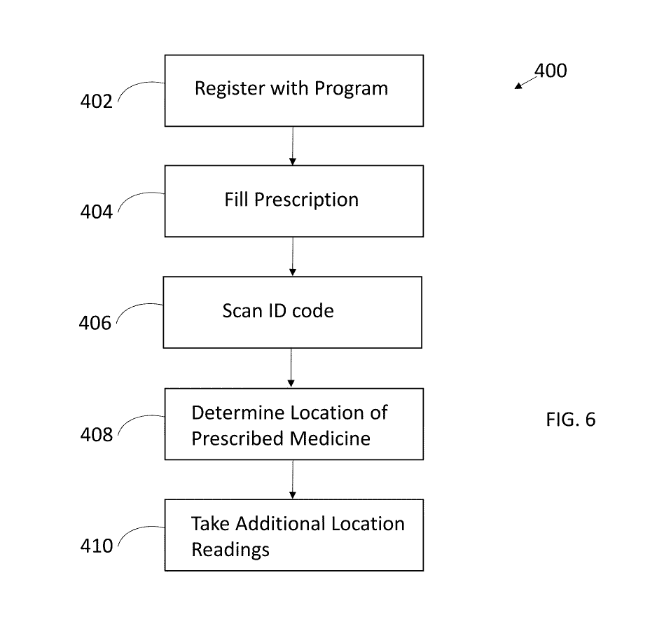

FIG. 6 is a flowchart of a method 400 for tracking a medication recipient, in accordance with some embodiments. In describing the method 400, reference is made to embodiments herein. Some or all of the method can be executed by elements of the medicine administration environment of FIG. 1.

At step 402, the entities register with a medicine administration program at registration system 22, for example, similar to embodiments herein described with reference to FIG. 1. Entities may include but not be limited to organizations such as the pharmacy 14 and/or administering facility 16, and/or other entities such as hospitals, clinics, companies, educational institutes, government offices, and so on. Other entities who may enroll may include the medicine recipient 11, and/or parent 13 or guardian, and/or caregiver 15 and/or other interested party such as a doctor, a nurse, and so on.

To access the registration system 22, the entities (facility, pharmacy, guardian, parent, and so on) can have an application installed on the electronic device to identify the entities for security purposes. Enrollment in this manner permits the parent 13, guardian, or other representative of the recipient 11 to authorize access to medical data regarding the recipient 11.

Information about the intended medicine recipient 11, the medicine, dosage, delivery, and so on can be entered at the registration system 22, and collected and stored in the database 32. Other information gathered during enrollment at the registration system 22 can include medicine details, administration instructions, and so on.

At step 404, a medicine prescription is filled, for example, at the pharmacy 14. The medicine is placed in a bottle or other container 19 that includes an identifier, for example, ID code described in other embodiments. The medicine 19 can be provided to a custodian 13, or recipient 11, caregiver 15, or other registered person authorized to receive the medicine 19. Alternatively, the medicine 19 can be delivered to the custodian 13, recipient 11, caregiver 15, or other registered authorized person at a different location (L2) than the location (L1) where the medicine prescription is filled. When the prescription is filled or refilled, an ID code or the like is placed on the medicine container, or updated, which can be scanned as doses of the medicine are administered, and as the remaining quantity of medicine in the container is reduced.

At step 406, the ID code on the container holding the medicine may be scanned, for example, by the custodian 13, recipient 11, caregiver 15, or other registered authorized person. The ID code can link and uniquely identify the filled prescription of the customer to a customer's medical data file or record stored on the pharmacy server 142 and/or at the database 32 at a remote location.

At block 408, the location of the prescribed medicine 19 is determined, by associating a GPS reading from the mobile electronic device 17 with the action being recorded. Each time a scan is taken, the current location of the medicine 19 is captured and stored, along with the action taken indicated by the user on the mobile phone application.

An application executed at the electronic device 17 can capture data related to an action as follows. Before, during, or after an interaction with the recipient 11, the caregiver 15 can scan a QR code or related code on the container holding the medicine 19. Other examples may include but not be limited to an RFID or other chip technology. When the container is scanned, the GPS location is captured and transmitted by the device 17 to the location analysis system 40, which can record the location position with the date and time and associate it with the patient's medication prescription. This enables authorized parties to see where the medication was administered.

When the container is scanned, the GPS location is captured and transmitted by the smart device to the central computer. The central computer records these location positions with the date and time and associates it with the patient's medication prescription. This enables authorized parties to see where the medication was administered.

At step 410, additional location readings can be taken. For example, GPS readings can be taken on a predetermined times, for example, 5 seconds apart. This data can be received by the tracking interface module 42 and processed by the location processor 45.

At step 412, the information can be displayed for review by the custodian 13, recipient 11, caregiver 15, or other person. Additional medical information can be recorded, for example, by the custodian 13, recipient 11, caregiver 15, and so on. Additional information may include but not be limited to dosage amount, time of dosage, deviations with respect to the administration of medicine, instructions, such as a requirement that the medication be taken with food, not taken with milk, and so on.

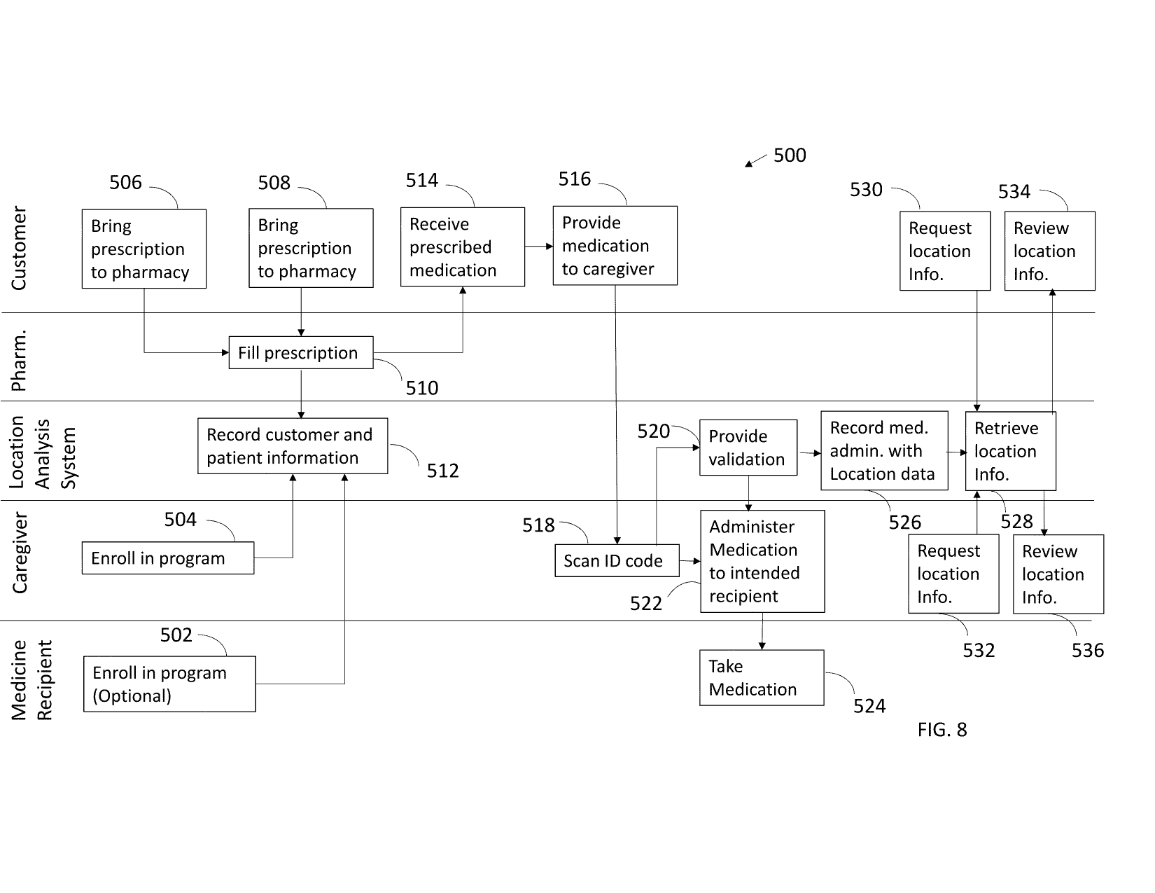

FIG. 7 is a component model of an environment in which embodiments of the present inventive concepts are practiced. FIG. 8 is a location tracking process flow, in accordance with some embodiments. In describing the process flow 500, reference is made at least to FIGS. 1 and 7.

At block 502, a medicine recipient 11 may, but is not required to, enroll in a medicine administration program, for example, described herein.

At block 504, the caregiver 15 may enroll in the same medicine administration program as the medicine recipient 11.

At block 506, a customer on behalf of the medicine recipient 11 brings a prescription to the pharmacy 14. A caregiver 15, guardian 13, or other representative person may be a customer, authorized to purchase medication.

At block 508, the customer may enroll in the same medicine administration program as the caregiver 15.

At block 510, the pharmacy 14 fills the prescription. The customer may enroll in the medicine administration program at the pharmacy 14 in cases where the customer is a new customer or otherwise not enrolled.

At block 514 the pharmacy 14 provides the prescribed medication 19 to the customer 15, and at block 516, the customer provides the prescribed medication to the caregiver 15. In some embodiments, the customer and the caregiver 15 are the same person.

At block 512, the location analysis system 40 records customer information, patient information, determined from program enrollment data.

At block 518, the caregiver 15 scans the ID code on the container holding the prescribed medication after receiving the prescribed medication 19.

At block 520, the location analysis system 40 validates, using the authorization system 47, the data provided in response to the scanning of the ID code. The user may perform an authorization action such as entering a code, scanning a personal barcode, biometric scan, or the like. The authorization system 47 may confirm that the user requesting authorization is indeed authorized to review personal information. Assuming authorization, the location analysis system 40 can return patient information after receiving a scanned code, where the information may be displayed at the user's mobile electronic device or other electronic display.

At block 522, the caregiver 15 administers a dose of the medication 19 to the medicine recipient 11. At block 524, the recipient 11 receives the medication 19.

At block 526, data related to the administration of the dose of medication by the caregiver 15 to the medication recipient 11 is recorded by the location analysis system 40, and in particular, stored in the location storage device 44, along with the location of the caregiver 15 at the time of the administration of the dose of medication.

At blocks 528, 530 the caregiver 15 and/or customer, respectively, may request location information. The location information may be used to ensure that medication is administrated at the appropriate locations. Inventory for a patient may be stored at different locations, for example, a home, school, workplace, after-school program, etc. Inventory levels must be determined at each location to ensure that inventory levels are not depleted at a particular location. At block 532, the location analysis system 40 retrieves the requested location information, and at blocks 534, 536, respectively, may provide the requested location information to the caregiver 15 and/or customer.

As shown in FIG. 8, an analyst 21, management representative 23, or other party may be part of a program to evaluate the usage and effectiveness of the program. Summary information may be derived from the data generated in the method 400 and/or process flow 500 described herein, for example, and can be used to examine how the information is being used, how frequently scans are occurring, which user types are using the information, e.g., number of doctors, number of patients, number of caregivers, number of customers.

As will be appreciated by one skilled in the art, concepts may be embodied as a device, system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Computer program code for carrying out operations for the concepts may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Concepts are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor, for example, processor 34, of a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While concepts have been shown and described with reference to specific preferred embodiments, it should be understood by those skilled in the art that various changes in form and detail may be made therein without departing from the spirit and scope as defined by the following claims.

What is claimed is:

1. A system for medicine management, comprising:
a special purpose computer that associates collected data related to a medicine with an identification code that identifies an intended recipient of the medicine;
a database that stores the identification code and the data associated with the identification code;
a special purpose computer that determines whether a combination of the intended medicine recipient, the medicine, a time of administration of the medicine to the intended medicine recipient, and an administered dosage is correct; and
a notification generator that generates a notification and outputs the notification to a user-defined notification recipient distribution regarding at least one of an issuance of the medicine to the intended recipient or in response to a determination that the combination of the intended medicine recipient, the medicine, the time of administration of the medicine to the intended medicine recipient, and the administered dosage is incorrect.

2. The system of claim 1, further comprising a tracking system that receives data from the identification code on a container storing the medicine, and in response monitors the administration of medicine by the caregiver.

3. The system of claim 2, further comprising a scanning device that scans the identification code to retrieve the data from the identification code prior to administering a dose of the medicine to the intended recipient.

4. The system of claim 3, wherein the notification includes at least one of a notification when the scanning device does not scan the identification or a notification in response to monitoring the administration of the medicine.

5. The system of claim 1, wherein the identification code includes a quick response (QR) code.

6. The system of claim 1, wherein the notification includes at least one of a proactive alert, a reactive alert, and a neutral alert.

7. The system of claim 1, wherein the user-defined notification recipient distribution includes at least one of a caregiver, a family member, a friend, or other non-medical person.

8. The system of claim 1, further comprising a server that includes entity enrollment data, and wherein the notification generator outputs the notification according to the entity enrollment data.

9. The system of claim 1, further comprising a processor that receives from the database one or more of prescription data, delivery information, medical administration data, or other information from the medical data file corresponding to the recipient ID code, and in response generates an event result that used by the notification generator to generate the notification.

10. A method of providing information about an administration of medicine, comprising:
collecting data from a medicine prescription fill for an intended medicine recipient;
generating an identification code for an intended medicine recipient and co-locating the identification code with a container holding the medicine prescription fill;
creating a record that associates the collected data with the identification code;
designating, by a non-medical user, one or more notification recipients for receiving a notification regarding events related to an administration of medicine of the medicine prescription fill to the intended medicine recipient;
determining an event regarding at least one of the intended medicine recipient, the medicine, a time of administration of the medicine, a dosage of the medicine, or an administration route; and
generating the notification for the designated one or more notification recipients in response to determining the event.

11. The method of claim 10, further comprising:
determining the event prior to a scan of the identification code; and
generating the notification as a pre-scan notification in response to determining the event prior to the scan of the identification code.

12. The method of claim 11, further comprising:
scanning the identification code; and
displaying an identifier of at least one of the intended medicine recipient and the medicine.

13. The method of claim 12, further comprising:
determining the event in response to the scan of the identification code; and
generating the notification as a pre-administration notification in response to determining the event.

14. The method of claim 12, further comprising:
administering the dosage of the medicine to the intended medicine recipient;
determining the event in response to the scan of the identification code and the administering of the dosage of the medicine; and
generating the notification as a post-administration notification in response to determining the event.

15. A method of notification, comprising:
scanning an identification code on a container that includes medicine to identify an intended recipient of the medicine;
determining in response to the scan whether the intended recipient, the medicine, a time of administration of the medicine, and a dosage of the medicine is correct; and
generating a notification for a user-defined notification recipient distribution in response to a determination that at least one of the intended recipient, the medicine, the time of administration of the medicine, and the dosage of the medicine is incorrect.

16. The method of claim 15, further comprising:
determining the event prior to a scan of the identification code; and
generating the notification as a pre-scan notification in response to determining the event prior to the scan of the identification code.

17. The method of claim 15, further comprising:
scanning the identification code; and
displaying an identifier of at least one of the intended medicine recipient and the medicine.

18. The method of claim 17, further comprising:
determining the event in response to the scan of the identification code; and
generating the notification as a pre-administration notification in response to determining the event.

19. The method of claim 15, further comprising:
administering the dosage of the medicine to the intended medicine recipient;
determining the event in response to the scan of the identification code and the administering of the dosage of the medicine; and
generating the notification as a post-administration notification in response to determining the event.

20. A system for medication management, comprising:
a device that reads a scannable identification code on a container at a first location where a medication is provided to the container;
a device that provides an identification of a person receiving the medication for colocation on the container with the scannable identification code;
a first processor that generates an association between the identification and the scannable identification code;
a mobile electronic device at a second location that collects biometric data related to the person receiving the medication at a second location;
a second processor that compares the biometric data to the identification on the container, and determines the identity of the person receiving the medication; and
a notification generator that generates a notification for a user-defined notification recipient distribution in response to the comparison.

21. A system for locating a medication recipient, comprising:
a tracking system interface that communicates with a mobile electronic device proximal to a source of medication to receive from the mobile electronic device data related to a location of the mobile electronic device;
a location processor that outputs the data related to the location of the mobile electronic device to a location storage device in response to an action performed at the location with respect to the source of medication;
an action recording device that receives from the mobile electronic device data related to the action; and
the location storage device for storing a record formed that combines the location data with the data related to the action performed at the current location.

22. The system of claim 21, further comprising a report generator for generating a communication regarding at least one of the action or the location data.

23. The system of claim 21, further comprising an application executed on the mobile electronic device that tracks the location of the source of medication.

24. The system of claim 23, wherein the action includes scanning by the mobile electronic device a code associated with the medication, and wherein a current location is established and stored in response to the scanning.

25. The system of claim 21, wherein the location processor determines whether a medication recipient is in transit while receiving a dose of the source of medication.

26. The system of claim 21, wherein the location processor determines source inventory supply levels.

27. The system of claim 21, wherein the location processor retrieves the data related to the location from the mobile electronic device in possession by a recipient or caregiver of the medication.

28. The system of claim 27, wherein the mobile electronic device displays a result indicating a location of the recipient or caregiver relative to the medication.

29. The system of claim 21, wherein the location data is processed to determine where a recipient last took the medication for maintaining inventories at the different locations.

30. The system of claim 21, wherein the tracking system interface receives a location signal from the mobile electronic device on a predetermined basis, which is used by the location processor to establish whether the mobile electronic device is in transit while taking medication, or to determine how far the mobile electronic device is from the medication.

31. A method for tracking a medication recipient, comprising:
registering with a program;
filling a prescription for medication in accordance with the program;
scanning an identifier on a container holding the medication; and
determining a location of the prescribed medication in response to scanning the identifier.
